(19) United States
(12) Patent Application Publication
(10) Pub. No.: US 2024/0379001 A1
(43) Pub. Date: Nov. 14, 2024

(54) INFORMATION PROCESSING DEVICE

(71) Applicant: TOYOTA JIDOSHA KABUSHIKI KAISHA, Toyota-shi (JP)

(72) Inventor: Kiyoaki MORIMOTO, Kasugai-shi (JP)

(73) Assignee: TOYOTA JIDOSHA KABUSHIKI KAISHA, Toyota-shi (JP)

(21) Appl. No.: 18/438,679

(22) Filed: Feb. 12, 2024

(30) Foreign Application Priority Data
May 9, 2023 (JP) 2023-077021

(51) Int. Cl. G08G 1/14

(52) U.S. Cl. CPC G08G 1/143

(57) ABSTRACT

An information processing device includes a control unit configured to execute: acquiring a parking point of a vehicle; acquiring a first point that is a point where the vehicle first enters within a first predetermined distance from the parking point; acquiring a first distance actually traveled by the vehicle from the first point to the parking point; acquiring a second distance along a predetermined route from the first point to the parking point; and outputting an index according to the behavior of the vehicle before parking in accordance with a comparison between the first distance and the second distance.

### CROSS-REFERENCE TO RELATED APPLICATION

This application claims priority to Japanese Patent Application No. 2023-077021 filed on May 9, 2023, incorporated herein by reference in its entirety.

### BACKGROUND

### 1. Technical Field

The disclosure relates to an information processing device.

### 2. Description of Related Art

Japanese Unexamined Patent Application Publication No. 2022-037197 (JP 2022-037197 A) discloses that information on the availability of parking lots around a destination is acquired in real time and guidance is provided on a route to a parking lot that meets a condition.

### SUMMARY

An object of the present disclosure is to provide an index about the fact that a vehicle has traveled to seek a parking lot.

One aspect of the present disclosure relates to an information processing device including a control unit configured to acquire a parking point of a vehicle, acquire a first point where the vehicle first enters a range of a first predetermined distance from the parking point, acquire a first distance actually traveled by the vehicle from the first point to the parking point, acquire a second distance on a predetermined route from the first point to the parking point, and output an index associated with behavior of the vehicle before parking based on comparison between the first distance and the second distance.

Other aspects of the present disclosure relate to an information processing method causing a computer to perform the above information processing, a program causing the computer to perform the information processing method, and a non-transitory computer-readable storage medium storing the program.

According to the present disclosure, it is possible to provide the index about the fact that the vehicle has traveled to seek a parking lot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment;

FIG. 2 is a diagram showing a travel trajectory of the vehicle assuming that the vehicle travels from the first point toward the parking point from the beginning;

FIG. 3 is a block diagram schematically showing an example of the configuration of a vehicle and a server that constitute the system according to the embodiment;

FIG. 4 is a flowchart showing a process of outputting a parking distance difference in the server in the first embodiment; and

FIG. 5 is a flowchart showing a process of outputting a parking distance difference in a server in the second embodiment.

### DETAILED DESCRIPTION OF EMBODIMENTS

If a parking lot becomes full before the user arrives at the parking lot guided by the vehicle's navigation system, the user must look for another parking lot. If the navigation system does not provide information about parking availability, users may drive around the neighborhood to find an available parking point on their own. If many vehicles run around looking for parking spaces in this way, there is a risk that traffic jams will occur. Furthermore, there is a risk that user satisfaction may decrease at tourist spots and the like. On the other hand, even if traffic jams occur due to such causes, it may be difficult to distinguish them from cases where traffic jams occur due to other causes. This may make it difficult to take appropriate measures to alleviate traffic congestion.

In order to solve such a problem, an information processing device that is one aspect of the present disclosure includes a control unit configured to execute: acquiring a parking point of a vehicle; acquiring a first point that is a point where the vehicle first enters within a first predetermined distance from the parking point; acquiring a first distance actually traveled by the vehicle from the first point to the parking point; acquiring a second distance along a predetermined route from the first point to the parking point; and outputting an index according to the behavior of the vehicle before parking in accordance with a comparison between the first distance and the second distance.

The parking location of the vehicle can be obtained, for example, by receiving from the vehicle a detection value from a position information sensor mounted on the vehicle. The parking location of the vehicle is, for example, the location where the vehicle's power switch was operated and the vehicle system was shut down, the location where the IG-ON state was changed to the IG-OFF state, or the location where the door was locked from the outside of the vehicle. Examples include location. The first predetermined distance is a distance that causes a difference in travel distance between when the vehicle runs around to search for a parking point before parking at the parking point and when the vehicle parks toward the parking point from the beginning. The first predetermined distance is, for example, 1 km. The first point is the point where the vehicle first enters within the first predetermined distance from the parking point, so in one trip, the vehicle subsequently moves outside the first predetermined distance from the parking point and again within the first predetermined distance. Even if you enter, the first point will not change. The first distance is the distance that the vehicle actually traveled from the first point to the parking point. This first distance can be acquired, for example, according to the travel history of the vehicle.

The control unit also obtains a second distance on the predetermined route. The predetermined route is, for example, the route of the vehicle when the vehicle travels with the parking point as the target point from the beginning. The predetermined route may be, for example, the shortest route from the first point to the parking point. The shortest route is, for example, a route that allows a vehicle to travel the shortest distance on a passable road. Further, as another example, the predetermined route may be a general route from the first point to the parking point. For example, the predetermined route may be a route that is preferentially selected from roads that are relatively easy for vehicles to pass, such as arterial roads. Alternatively, as another example, the predetermined route may be a route that is assumed to be a straight line from the first point to the parking point. In this case, the second distance is equal to the first predetermined distance.

Here, the difference between the first distance and the second distance becomes larger as the vehicle runs around to search for a parking lot. In other words, the larger the difference between the first distance and the second distance, the longer the distance traveled by the vehicle in search of a parking lot. Therefore, the difference between the first distance and the second distance can be treated as an index according to the behavior of the vehicle before parking. By outputting this index, it is possible to review the method of guiding the vehicle to the parking lot, for example. Note that, as another example, the ratio between the first distance and the second distance may be used as an index according to the behavior of the vehicle before parking.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

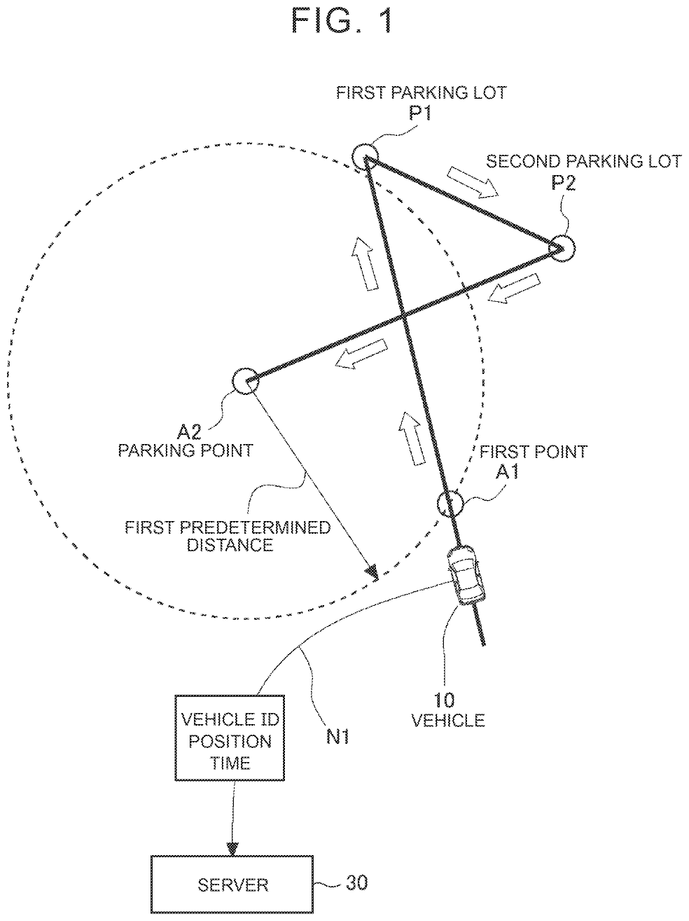

FIG. 1 is a diagram schematically showing a system 1 according to an embodiment. In the example of FIG. 1, system 1 includes a vehicle 10 and a server 30. In FIG. 1, one vehicle 10 is illustrated as an example, but the present disclosure is not limited to this, and a plurality of vehicles 10 may exist. The vehicle 10 and the server 30 are connected together via a network N1. The network N1 is, for example, a world-wide public communication network such as the Internet, and a wide area network (WAN) or other communication networks may be adopted. In addition, the network N1 may include a telephone communication network such as a mobile phone network and a wireless communication network such as Wi-Fi (registered trademark).

FIG. 1 shows a travel trajectory of the vehicle 10 until the vehicle 10 parks at a parking point A2. In FIG. 1, a white arrow indicates the direction in which the vehicle 10 is traveling. First, the vehicle 10 has passed through the first point A1. The first point A1 is the point where the vehicle 10 first enters within a first predetermined distance from the parking point A2. The first entry point here is, for example, the first entry point of the vehicle 10 on the trip immediately before parking at the parking point A2. The vehicle 10 is traveling from a first point A1 toward a first parking lot P1. However, since the first parking lot P1 was full, the vehicle 10 is now traveling toward the second parking lot P2. However, since the second parking lot P2 was also full, the vehicle continued to drive towards parking point A2 and finally parked in the parking point A2. In this way, the vehicle 10 reaches the parking point A2 after passing through the first point A1, the first parking lot P1, and the second parking lot P2. In this way, the vehicle 10 reaches the parking point A2 by running around inside and outside the first predetermined distance from the parking point A2.

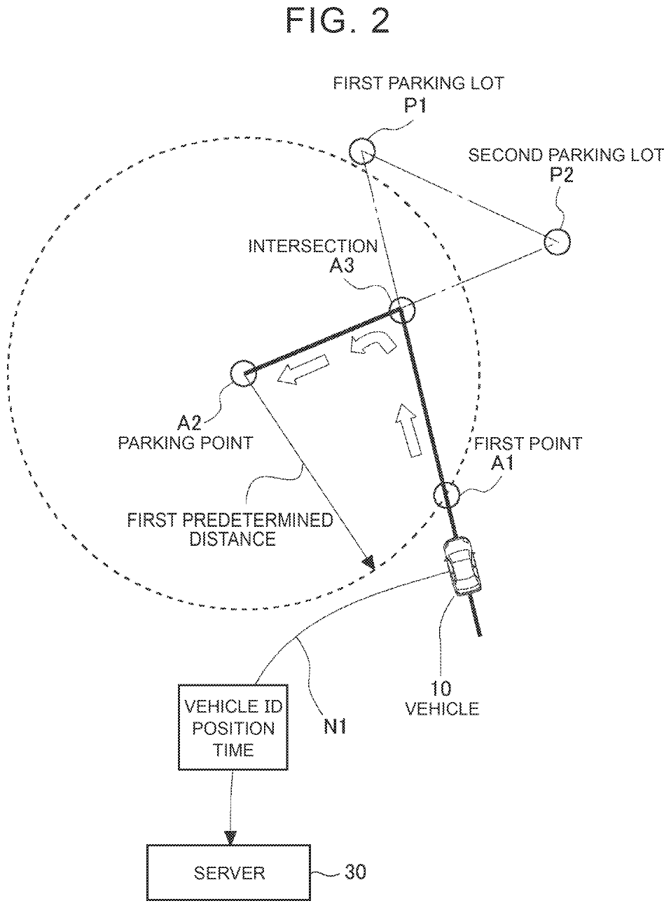

On the other hand, FIG. 2 is a diagram showing a travel trajectory of the vehicle 10 assuming that the vehicle 10 travels from the first point A1 toward the parking point A2 from the beginning. In FIG. 2, a white arrow indicates the direction in which the vehicle 10 is traveling. The vehicle 10 has arrived at the parking point A2 from the first point A1 via the intersection A3. The difference between the actual traveling distance (first distance) of the vehicle 10 shown in FIG. 1 and the hypothetical traveling distance (second distance) of the vehicle 10 shown in FIG. 2 corresponds to the distance returning to the intersection A3 via the first parking P1 and the second parking lot P2 from the intersection A3. This difference in distance can be said to be the distance that the vehicle 10 travels in vain to search for a parking lot. The shorter the difference in distance, the shorter the travel time, which increases user satisfaction and reduces traffic jams.

Therefore, the server 30 outputs an index according to the behavior of the vehicle 10 before parking, according to the comparison between the first distance and the second distance. For example, this index is an index indicating how far the vehicle 10 has traveled in search of a parking lot. This index is output as, for example, the difference between the first distance and the second distance. Note that, as another example, this index may be output as a ratio between the first distance and the second distance. For example, the server 30 causes the display to display the difference between the first distance and the second distance.

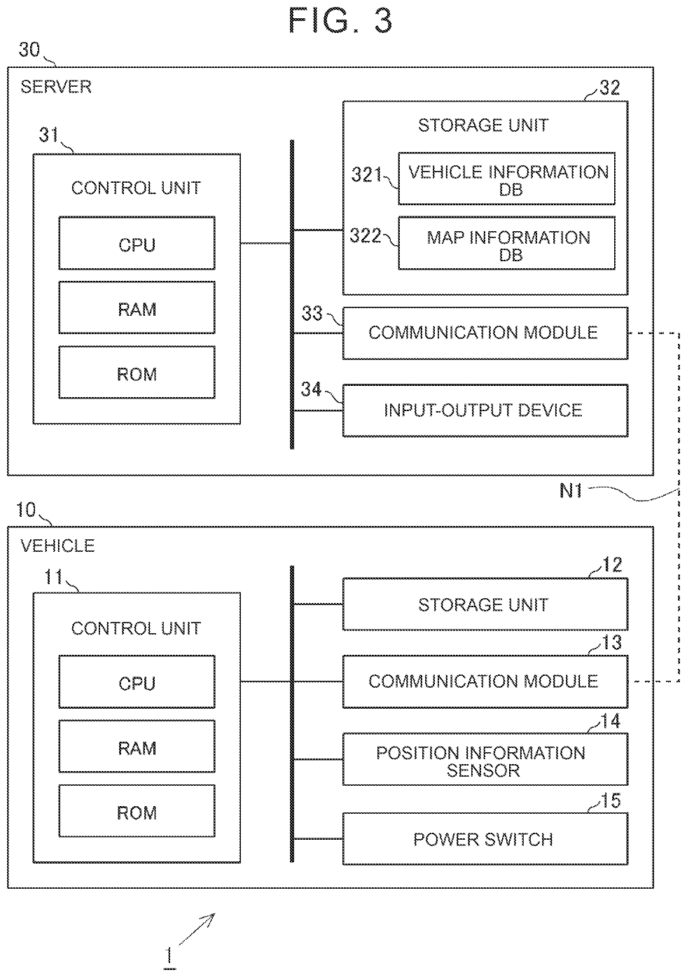

Next, the hardware and software configurations of the vehicle 10 and the server 30 will be described based on FIG. 3. FIG. 3 is a block diagram schematically showing an example of the respective configurations of the vehicle 10 and the server 30 that constitute the system 1 according to the present embodiment. The server 30 includes a control unit 31, a storage unit 32, a communication module 33, and an input/output device 34.

The server 30 can be configured as a computer having a processor (CPU, GPU, etc.), a main storage device (RAM, ROM, etc.), and an auxiliary storage device (EPROM, hard disk drive, removable media, etc.). The auxiliary storage device stores an operating system (OS), various programs, various tables, etc., and by executing the programs stored there, each function (software module) matching a predetermined purpose described below can be realized. However, some or all of the modules may be realized as a hardware module by, for example, a hardware circuit such as an ASIC or an FPGA.

The control unit 31 is an arithmetic unit that implements various functions of the server 30 by executing a predetermined program. The control unit 31 can be realized by, for example, a hardware processor such as a CPU. Further, the control unit 31 may include a RAM, a ROM (Read Only Memory), a cache memory, and the like. Details of the control unit 31 will be described later.

The storage unit 32 is a means for storing information, and is composed of a storage medium such as a RAM, a magnetic disk, or a flash memory. The storage unit 32 stores programs executed by the control unit 31, data used by the programs, and the like. Further, databases (vehicle information DB 321 and map information DB 322) are constructed in the storage unit 32, and vehicle information and map information collected from each vehicle 10 are stored in the database.

The vehicle information DB 321 stores position information and time information of the vehicle 10 in association with the vehicle ID. The position information and time information are linked to the vehicle ID and transmitted from the vehicle 10 at predetermined time intervals. Further, the vehicle information DB 321 stores the activation state of the system of the vehicle 10. For example, the time when the system of the vehicle 10 was started (power-on time) and the time when the system was shut down (power-off time) are stored. Hereinafter, the vehicle ID, location information, time information, and information regarding the activation state of the system of the vehicle 10 will be collectively referred to as vehicle information. The control unit 31 stores the vehicle information received from the vehicle 10 in the vehicle information DB 321.

The map information DB 322 also includes, as map information, link data regarding roads (links), node data regarding node points, intersection data regarding each intersection, search data for searching routes, section data regarding sections, and Lane data regarding the number of lanes, etc. are stored.

The communication module 33 is a communication interface for connecting the server 30 to the network N1. The communication module 33 may be configured to include, for example, a network interface board, a wireless communication interface for wireless communication, and the like. The server 30 can perform data communication with each vehicle 10 via the communication module 33.

The input/output device 34 is a means for accepting input operations performed by an operator and presenting information to the operator. Specifically, the input/output device 34 includes a device for performing input such as a mouse and a keyboard, and a device for performing output such as a display and a speaker. The input/output device 34 may be integrally configured with, for example, a touch panel display.

Note that in the specific hardware configuration of the server 30, components can be omitted, replaced, or added as appropriate depending on the embodiment.

Next, the vehicle 10 will be described. The vehicle 10 includes a control unit 11, a storage unit 12, a communication module 13, a position information sensor 14, and a power switch. The control unit 11 is an arithmetic unit that implements various functions of the vehicle 10 by executing predetermined programs. The control unit 11 can be realized by, for example, a hardware processor such as a CPU. Further, the control unit 11 may include a RAM, a ROM (Read Only Memory), a cache memory, and the like.

The storage unit 12 is a means for storing information, and is constituted by a storage medium such as a RAM, a magnetic disk, or a flash memory. The storage unit 12 stores programs executed by the control unit 11, data used by the programs, and the like. The storage unit 12 stores detection values of the position information sensor 14.

The communication module 13 is a communication means for connecting the vehicle 10 to the network N1. In this embodiment, the vehicle 10 can communicate with other devices (for example, the server 30) via the network N1 using mobile communication services such as 3G, LTE, 5G, and 6G.

The position information sensor 14 acquires position information (for example, latitude and longitude) of the vehicle 10 at a predetermined period. The position information sensor 14 is, for example, a GPS (Global Positioning System) receiving unit, a wireless communication unit, or the like.

The power switch 15 is a switch for changing the starting state of the vehicle 10, and is a switch for starting the vehicle 10 or stopping the functions of the vehicle 10 when pressed by the driver. Note that the state in which the driver presses the power switch 15 to start the vehicle 10 is referred to as a power-on state, and the state in which the user presses the power switch 15 again and the vehicle 10 stops functioning is referred to as a power-off state. Power switch 15 may be an IG switch. The power-on state corresponds to the IG-on state, and the power-off state corresponds to the IG-off state.

The control unit 11 of the vehicle 10 transmits the detection value of the position information sensor 14 and the activation state of the vehicle 10 to the server 30 together with the vehicle ID and time information at predetermined intervals. In this way, the control unit 11 of the vehicle 10 transmits vehicle information to the server 30 at predetermined intervals. Note that the starting state of the vehicle 10 may be transmitted to the server 30 only when the driver operates the power switch 15. Here, if the system of the vehicle 10 is not activated, the server 30 can determine that the vehicle 10 is in the parked state.

Next, the control unit 31 of the server 30 will be explained in detail. The control unit 31 of the server 30 calculates a first distance, which is the actual traveling distance of the vehicle 10 from the first point A1 to the parking point A2, based on the vehicle information acquired from the vehicle 10. Therefore, the control unit 31 specifies the parking point A2 of the vehicle 10 and the first point A1, which is the point where the vehicle 10 first enters within a first predetermined distance from the parking point A2. The parking point A2 is acquired from the vehicle information as, for example, the point where the system of the vehicle 10 was shut down. The first point A1 is acquired from the vehicle information as the point where the vehicle 10 first enters within a first predetermined distance from the parking point A2 during a trip in which the vehicle 10 moves to the parking point A2. The first distance can be calculated by calculating and integrating the travel distance between each time from the position of the vehicle 10 at each time from the first point A1 to the parking point A2.

Furthermore, the control unit 31 of the server 30 calculates a second distance. Therefore, the control unit 31 generates the shortest route from the first point A1 to the parking point A2. The shortest route is a route with the shortest distance among the routes that the vehicle 10 can travel from the first point A1 to the parking point A2. This shortest route may be a route that is presented when the navigation system searches for a route from the first point A1 to the parking point A2.

Then, the control unit 31 calculates the difference between the first distance and the second distance. This difference is called a parking distance difference. The parking distance difference corresponds to the additional distance traveled by the vehicle 10 in order to search for a parking lot. After calculating the parking distance difference, the server 30 outputs it from the input/output device 34. At this time, for example, the parking distance difference is displayed on the display.

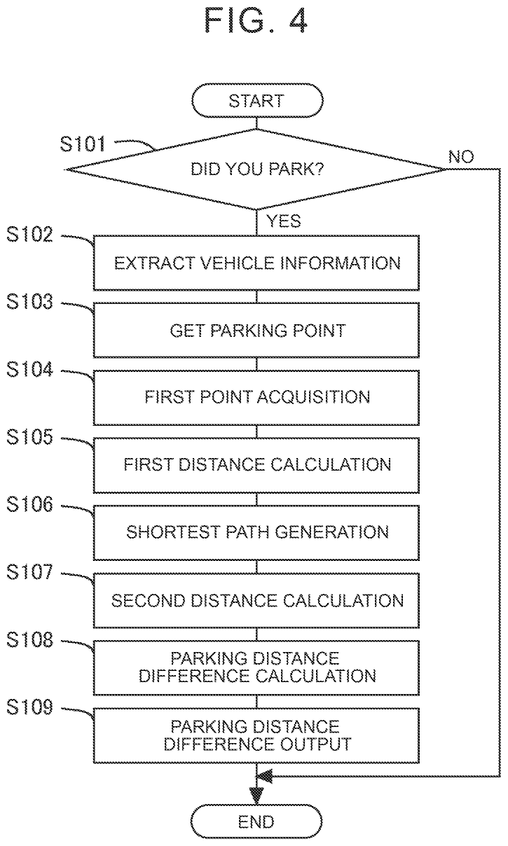

Next, the process of outputting the parking distance difference in the server 30 will be explained. FIG. 4 is a flowchart showing a process of outputting a parking distance difference in the server 30 in the first embodiment. The flowchart shown in FIG. 4 is executed for each vehicle 10 in an area (referred to as a target area) that provides an index according to the behavior of the vehicle 10 before parking. Note that the description will be made assuming that the vehicle information DB 321 stores vehicle information corresponding to a plurality of vehicles 10. The target area can be arbitrarily set by the operator of the server 30.

In S101, the control unit 31 determines whether the vehicle 10 is parked. For example, the control unit 31 determines that the vehicle 10 is parked when the power-on state (which may also be an IG-on state) changes to the power-off state (which may also be an IG-off state). The state of the power switch 15 (which may also be an IG switch) is included in the vehicle information transmitted from the vehicle 10 and is stored in the vehicle information DB 321. If an affirmative determination is made in S101, the process proceeds to S102, and if a negative determination is made, this routine is ended.

In S102, the control unit 31 extracts vehicle information of the target vehicle 10 from the vehicle information DB 321. In S103, the control unit 31 acquires the parking point A2. The control unit 31 acquires the position at the time when the power switch 15 of the vehicle 10 is turned off as the parking point A2. Next, in S104, the control unit 31 acquires the first point A1. The control unit 31 acquires the first point within a first predetermined distance (for example, 1 km) from the parking point A2 as the first point A1. At this time, the first point A1 is specified from the change in the position of the vehicle 10 during the trip when the vehicle 10 arrives at the parking point A2.

In S105, the control unit 31 calculates a first distance. The control unit 31 calculates the distance that the vehicle 10 actually traveled from the first point A1 obtained in S104 to the parking point A2 obtained in S103. At this time, the control unit 31 calculates the distance actually traveled by the vehicle 10 from the change in the position of the vehicle 10. In S106, the control unit 31 generates the shortest route from the first point A1 obtained in S104 to the parking point A2 obtained in S103. The control unit 31 generates the shortest route using information stored in the map information DB 322. Known techniques can be used to generate this shortest route. Although the shortest route is generated in this routine, as another example, a route may be generated based on the travel history of other vehicles 10. For example, the shortest route among the routes traveled by the other vehicle 10 from the first point A1 to the parking point A2 may be generated in S106. As yet another example, a route traveled by the largest number of vehicles 10 among the routes traveled by other vehicles 10 from the first point A1 to the parking point A2 may be generated in S106. In this way, a realistic index can be obtained by comparing routes actually traveled by other vehicles 10. Further, as another example, a route connecting the first point A1 to the parking point A2 with a straight line may be generated in S106. By doing so, the shortest route can be easily generated without requiring map data. Therefore, the cost of using map data and the cost of searching for the shortest route become unnecessary.

In S107, the control unit 31 calculates the second distance. The control unit 31 calculates the distance of the shortest route generated in S106 based on the map information stored in the map information DB 322. A known technique can be used for this calculation. As another example, when a route connecting the first point A1 to the parking point A2 with a straight line is generated in S106, the first predetermined distance used in S104 can be used as the second distance.

In S108, the control unit 31 calculates the parking distance difference. The control unit 31 calculates the parking distance difference by subtracting the second distance calculated in S107 from the first distance calculated in S105. Then, in S108, the control unit 31 outputs the parking distance difference calculated in S108 as an index corresponding to the behavior of the vehicle 10 before parking. Note that the parking distance difference calculated in S108 may be stored in the storage unit 32, and the parking distance difference may be output in response to a request from the operator.

As described above, according to the present embodiment, the parking distance difference can be calculated and provided as an index according to the behavior of the vehicle 10 before parking at the parking point A2. This makes it possible to quantify how long one vehicle 10 was running around looking for a parking lot. That is, it becomes possible to determine how much wasted distance the vehicle 10 has traveled until it is parked. This index is correlated with user dissatisfaction levels and the likelihood of traffic jams occurring, so it can be used to improve these. It is also possible to provide the percentage of vehicles 10 that drove around looking for parking.

### Second Embodiment

In the second embodiment, the parking distance difference is calculated only for vehicles 10 whose distance from the starting point of the vehicle 10 to the parking point A2 is greater than or equal to the second predetermined distance. Here, the parking distance difference provided in the first embodiment can be provided, for example, as an index when a tourist runs around a tourist spot in order to search for a parking lot at the tourist spot. However, if we include the cases where people who live in tourist areas run around tourist areas to do their daily shopping, etc., it would not fit the purpose. Therefore, in the second embodiment, the parking distance difference is provided by excluding the behavior of the vehicle 10 of a local resident. Here, it is considered that the starting point of the local resident's vehicle 10 is at a certain distance from the parking point A2. Therefore, by calculating the parking distance difference only for vehicles 10 whose distance from the starting point of the vehicle 10 to the parking point A2 is equal to or greater than the second predetermined distance, it is possible to exclude the vehicles 10 of local residents. The second predetermined distance is stored in the storage unit 32 as a distance that can exclude local residents' vehicles 10.

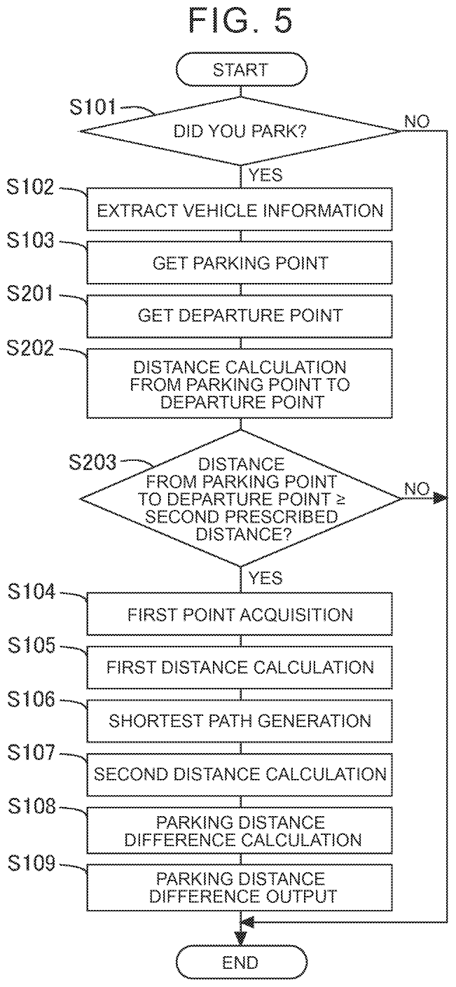

Next, the process of outputting the parking distance difference in the server 30 will be explained. FIG. 5 is a flowchart showing a process of outputting a parking distance difference in the server 30 in the second embodiment. The flowchart shown in FIG. 5 is executed for each vehicle 10 in the target area. Note that the description will be made assuming that the vehicle information DB 321 stores vehicle information corresponding to a plurality of vehicles 10. Furthermore, descriptions of steps in which the same processing as in the flowchart shown in FIG. 4 is executed will be omitted.

In the flowchart shown in FIG. 5, when the process of S103 is completed, the process advances to S201. In S201, the control unit 31 acquires a starting point. The starting point is the point from which the vehicle 10 departed on the trip to the parking point A2. This starting point is the point where the power switch 15 is operated and the state changes from the power-off state to the power-on state. In S202, the control unit 31 calculates the distance from the parking point A2 obtained in S103 to the departure point obtained in S201. This distance is, for example, a straight line distance. Then, in S203, the control unit 31 determines whether the distance calculated in S202 is equal to or greater than a second predetermined distance. If an affirmative determination is made in S203, the process proceeds to S104, and if a negative determination is made, this routine is ended.

As described above, according to the present embodiment, it is possible to provide more accurately an index according to the behavior of the vehicle 10 before parking.

### OTHER EMBODIMENTS

The above embodiments are only examples, and the disclosure may be carried out with various modifications without departing from the essence thereof. The processes and means described in the present disclosure can be freely combined and implemented as long as no technical contradiction occurs. Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

Furthermore, for example, the first predetermined distance for specifying the first point may be set depending on the density of parking lots. For example, if the distance between parking lots is long and the first predetermined distance is made relatively short, the vehicle 10 may run around looking for a parking lot outside the first predetermined distance. Therefore, a more realistic index can be obtained by setting the first predetermined distance according to the range in which the vehicle 10 is expected to run. Therefore, the lower the density of the parking lot, the longer the first predetermined distance may be.

The control unit 31 also acquires a first ratio, which is the ratio of vehicles 10 for which the difference between the first distance and the second distance is greater than or equal to a predetermined difference among the plurality of vehicles 10 during the busy season, and during the off-season. Obtaining a second ratio which is the ratio of vehicles 10 for which the difference between the first distance and the second distance is equal to or greater than a predetermined difference among the plurality of vehicles 10, and calculating the ratio obtained by subtracting the second ratio from the first ratio, output as a percentage of vehicles 10 that searched for a parking lot during the busy season. Here, the behavior during the off-season is thought to correspond to the daily life of local people. Moreover, the vehicles 10 of local residents exhibit the same behavior even during the busy season as they do during the off-season. Since this behavior is not a behavior for searching for a parking lot, the accuracy of the index can be improved by excluding it from the proportion of vehicles 10 that searched for a parking lot during the busy season.

Further, when the vehicle 10 stops at a predetermined facility, the control unit 31 may acquire the distance that the vehicle 10 actually traveled from the predetermined facility to the parking point A2 as the first distance. Here, since driving to a predetermined facility where pick-up and drop-off etc. are performed is not a behavior for searching for a parking lot, the accuracy of the index can be improved by treating the subsequent behavior as the behavior of the vehicle 10 searching for a parking lot. can. The predetermined facility is, for example, a station or a school.

The disclosure can also be implemented by providing a computer program in which the functions described in the embodiments are implemented to a computer, and by one or more processors included in the computer reading and executing the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit configured to:
acquire a parking point of a vehicle;
acquire a first point where the vehicle first enters a range of a first predetermined distance from the parking point;
acquire a first distance actually traveled by the vehicle from the first point to the parking point;
acquire a second distance on a predetermined route from the first point to the parking point; and
output an index associated with behavior of the vehicle before parking based on comparison between the first distance and the second distance.

2. The information processing device according to claim 1, wherein the control unit is configured to acquire a distance on a shortest route as the second distance.

3. The information processing device according to claim 1, wherein the control unit is configured to acquire the first predetermined distance as the second distance.

4. The information processing device according to claim 1, wherein the control unit is configured to acquire, as the second distance, a distance stored in a storage unit and associated with a route from the first point to the parking point for another vehicle in a past.

5. The information processing device according to claim 1, wherein the control unit is configured to output the index only to a vehicle at a starting point that is a second predetermined distance or longer away from the parking point.
